(19) United States
(12) Patent Application Publication
(10) Pub. No.: US 2006/0294026 A1
(43) Pub. Date: Dec. 28, 2006

(54) Digital rights conversion system

(76) Inventors: Nicolaas Willem Schellingerhout, Eindhoven (NL); Maarten Peter Bodlaender, Eindhoven (NL); Willem Bulthuis, Eindhoven (NL); Pieter Voorwinden, Eindhoven (NL); Alexandre Sinitsyn, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/539,696

(22) PCT Filed: Nov. 18, 2003
(86) PCT No.: PCT/IB03/05272

§ 371 Date: Jun. 16, 2005

(30) Foreign Application Priority Data
Dec. 17, 2002 (EP) 02080501.6

(51) Int. Cl. G06Q 99/00; H04L 9/00; H04K 1/00

(52) U.S. Cl. 705/80

(57) ABSTRACT

The invention is based on the idea that a mechanism is introduced, by which it is possible to convert limited digital rights, which gives the proprietor of the digital rights access to the work a limited number of times, into an unlimited digital right, provided that the number of accesses associated with the limited light is sufficiently high. The present invention is advantageous since if a proprietor of limited rights associated with a digital content holds a sufficient number of limited rights, he/she is allowed to convert these limited rights into an unlimited right. The proprietor of the copyrighted content and/or the content distributor can thereby attract users to surf in to sites on the internet by in return offering limited digital rights to content, to buy media such as magazines, CDs ad DVDs to which rights are attached.

The present invention relates to a method and a system for converting digital rights.

In today's information society, the rapid spread of digital information has given birth to the concept of digital rights management (DRM). This concept is used to protect the rights of a creator of the digital information, typically called the digital content, as well as the rights of an information provider distributing the information or content. This concept is applicable to information distributed via any type of media, such as the Internet, a CD, a DVD or the like. It is also applicable to any type of information, for example audio, video, text etc. DRM technologies are thus used to protect copyrighted content from being pirated, misused and/or wrongly distributed.

Information can be distributed between a number of actors. The distribution can, for example, take place between a server and a stand-alone computer, between two or more stand-alone computers, between a mobile phone and a computer etc. The actual information distribution can attain many different forms; information is downloaded for permanent storage on a hard disk, information is streamed from a server, whereby permanent storage of the information is disabled, a single information copy is distributed, a large number of copies are distributed etc. As clearly can be seen, there are many aspects to consider when designing DRM systems.

A common digital right is the unlimited digital right, which gives its proprietor access to content, to which the right is associated, an unlimited number of times. This access can include various different types of access, for example “play”, “copy”, “burn to CD-R”, “transfer”, “download” etc. Thus, a typical digital right associated with audio content is “play unlimited”. However, limited digital rights are also common, giving its proprietor access to content, to which the rights are associated, a limited number of times. This access can also include various different types of access, for example “play for 24 hours”, “copy once”, “burn to CD-R once”, “transfer to a specific user group” etc.

U.S. Pat. No. 5,629,980 discloses a system for controlling use and distribution of digital works. Usage rights are associated to the digital work, the usage rights defining how a digital work can be used and distributed by a buyer of the work. Digital works are stored in a repository. A repository will process each request to access a digital work by examining the corresponding usage rights. Digital work playback devices coupled to the repository containing the work are used to play, display or print the work.

An object of the present invention is to provide a system and a method by which it is possible for a proprietor of copyrighted content and/or a content distributor to attract users to gather limited digital rights to the copyrighted content.

This object is achieved by a method for converting digital rights according to claim 1 and a system for converting digital rights according to claim 5. Preferred embodiments are defined by the dependent claims.

According to a first aspect of the invention, a method is provided in which digital content and associated limited digital rights are stored. The limited digital rights give a proprietor of the limited rights access to the content a limited number of times. When receiving an instruction in accordance therewith, the limited rights are converted into an unlimited digital right. The unlimited digital right gives a proprietor of the unlimited right access to the content an unlimited number of times.

According to a second aspect of the invention, a system is provided comprising storing means arranged to store digital content and associated limited digital rights. The limited digital rights give a proprietor of the limited rights access to the content a limited number of times. The system further comprises processing means arranged to convert the limited rights into an unlimited digital right, when receiving an instruction in accordance therewith. The unlimited digital right gives a proprietor of the unlimited right access to the content an unlimited number of times.

The invention is based on the idea that a mechanism is introduced, by which it is possible to convert limited digital rights, which gives the proprietor of the digital rights access to the content a limited number of times, into an unlimited digital right, provided that the number of accesses associated with the limited right is sufficiently high. It is possible to convert either a single limited right which allows a given limited number of accesses, or a number of limited digital rights which together allow the same given limited number of accesses as the single limited digital right, into an unlimited digital right. In other words, one single limited digital right giving its proprietor the right to access the content, for example, 50 times can be converted into an unlimited right. Alternatively, 50 separate limited digital rights each giving its proprietor the right to access the content one time can be converted into the same unlimited right. Moreover, the limited digital rights might have been drawn up in such a way that each of the limited rights allow the proprietor of the respective right a different number of accesses. For example, 10 single limited digital rights giving its proprietor the right to access the content 2 times together with 5 single limited digital rights giving the proprietor the right to 3 accesses and one single limited digital right giving the proprietor the right to 15 accesses can be converted into an unlimited right. The total number of accesses is still 50. When converting the limited right(s) into an unlimited right, an agreement must be made on how many accesses that is required in order for a conversion of limited digital rights into an unlimited right to be effected. Alternatively, this is agreed upon in advance.

The above described concept is advantageous since if a proprietor of limited rights associated with a digital content holds a sufficient number of limited rights, he/she is allowed to convert these limited rights into an unlimited right. The proprietor of the copyrighted content and/or the content distributor can thereby attract users to, for example, surf in to sites on the Internet by in return offering limited digital rights to content, or to buy media such as magazines, CDs ad DVDs to which rights are attached. The user knows that if she collects a sufficient number of limited rights, she is awarded with an unlimited right. The above described concept can preferably also be employed in advertisement, wherein potential customers can be offered limited digital rights when being exposed to the advertisement. By controlling the number of limited rights required to receive an unlimited right, the proprietor of the copyrighted content and/or the content distributor is not harmed. Rather, the conversion from limited rights into an unlimited right promotes the content and stimulates sales for the proprietor of the copyrighted content. The limited digital rights can be distributed on many types of media, for example as computer readable stickers (e.g. RF tags) on magazines, as binary files via the internet, as samples comprised in CDs or DVDs etc. This has the advantage that the sale of these media can be promoted by means of the attached limited digital rights.

According to an embodiment of the invention, the digital content and the associated limited digital rights are stored at a server of a digital content provider and the conversion of limited rights into an unlimited right is performed at the server, when the server receives a converting instruction from a device with computing capabilities operated by the proprietor of the digital rights. The proprietor of the digital rights, which rights are associated with the content, thereby have to establish connection with the server when converting the limited rights and maintaining the connection with the server when accessing the content. This has the advantage that since the digital content and the associated unlimited right are stored on a server of a digital content provider, the administration and managing of unlimited digital rights for the content provider is rather easy, since unlimited rights are not distributed outside the server. This also implies that advanced security facilities for protecting unlimited rights need not be employed. As the unlimited rights are kept within the controlled framework of the server, an unauthorized third party is prevented from eavesdropping on a network, by which the server and content consumers are interconnected, and accessing/stealing the rights.

According to another embodiment of the invention, digital content and associated digital rights are distributed from the server of a digital content provider, for storage at a device with computing capabilities operated by the proprietor of the digital rights. The fact that the digital content and the associated rights are stored at the device of the right proprietor is advantageous, since this gives the proprietor a larger degree of freedom in handling and distributing the contents and rights. The proprietor need not, apart from the step of converting limited rights to an unlimited right, operate via the server. Another advantage is that, when accessing the digital content, whether the access is of type play, copy, transfer etc., the proprietor need not be in contact with the server of the content provider at the time of access, since the content and associated rights are stored at the device of the proprietor of the digital rights.

According to yet another embodiment of the present invention, the conversion of the limited digital rights into an unlimited digital right, as well as the storing of digital content and the associated digital rights, is performed at the device with computing capabilities operated by the proprietor of the digital rights. To perform the conversion at the device of the digital right proprietor is advantageous, since it gives the proprietor a larger amount of freedom in handling the rights. It is not necessary for a proprietor to send a conversion instruction to the server via the network by which the proprietor and the content provider is interconnected. Consequently, the proprietor does not have to rely on a qualitative connection to the server, once the digital content and the associated right have been downloaded to the device. It also has the advantage that the distributor of the software module, typically the content provider or a partner to the provider, does not have to handle the conversion for content consumers connected to the server. DRM is sometimes experienced as restrictive to the content consumers. For content consumers to accept DRM, tools such as the present invention must be as smooth as possible to use when implemented in DRM systems.

Further features of, and advantages with, the present invention will become apparent when studying the appended claims and the following description. Those skilled in the art realize that different features of the present invention can be combined to create embodiments other than those described in the following. Many different alterations, modifications and combinations will become apparent for those skilled in the art. The described embodiments are therefore not intended to limit the scope of the invention, as defined by the appended claims.

Embodiments of the present invention will be described with reference made to the accompanying drawings, in which:

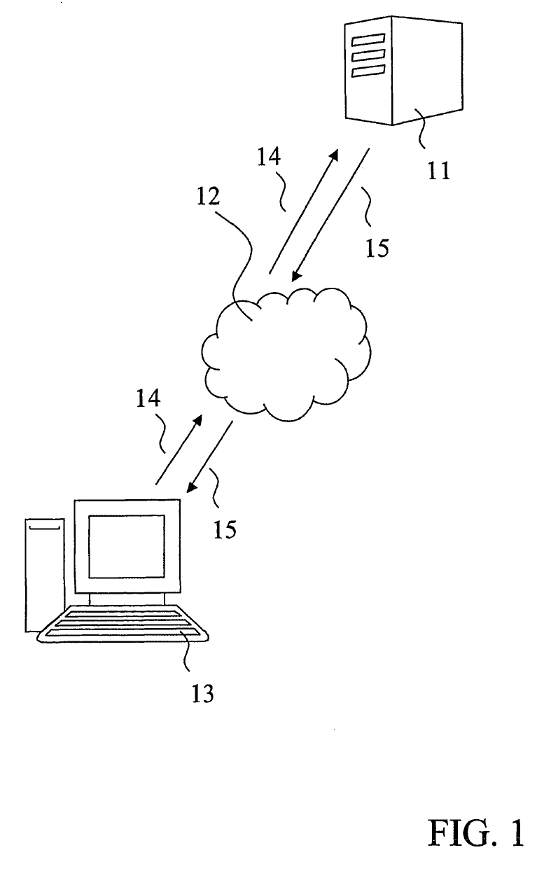

FIG. 1 shows a schematic representation of a system for converting digital rights according to an embodiment of the present invention;

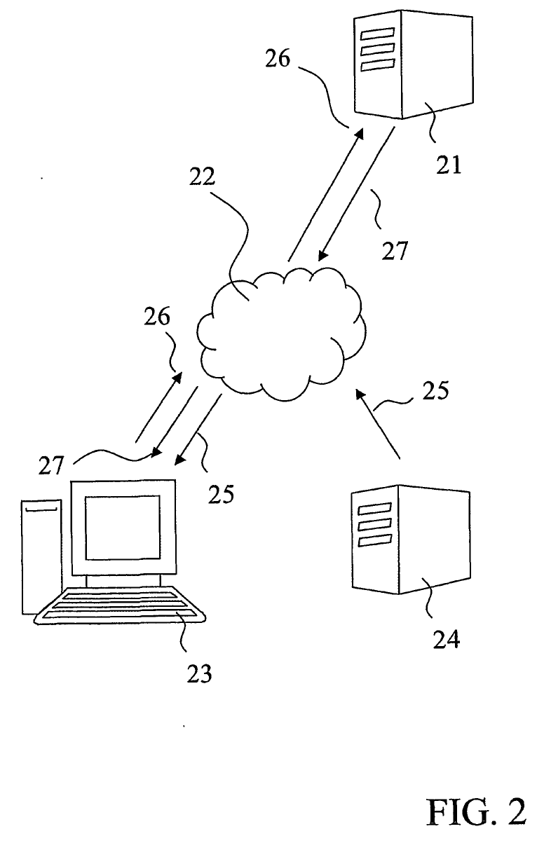

FIG. 2 shows a schematic representation of a system for converting digital rights according to another embodiment of the present invention; and

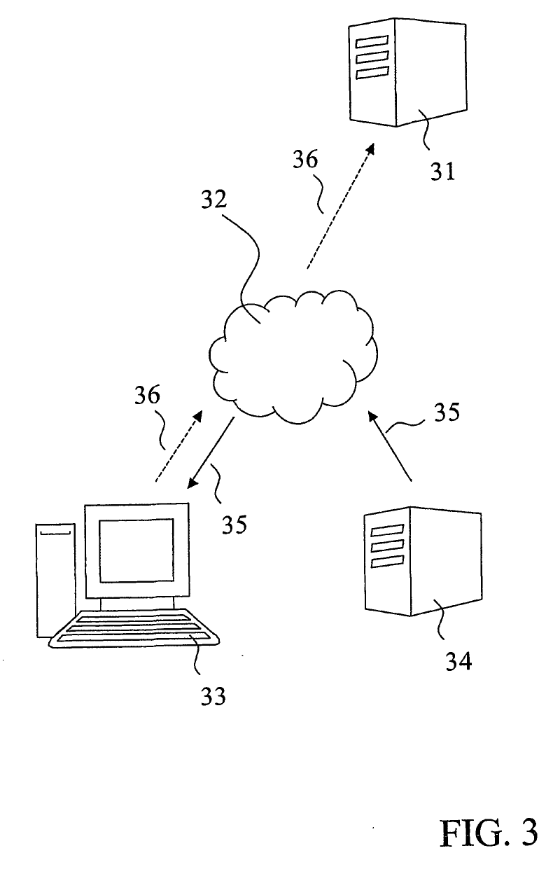

FIG. 3 shows a schematic representation of a system for converting digital rights according to yet another embodiment of the present invention.

FIG. 1 shows a schematic representation of a system for converting digital rights according to an embodiment of the present invention. A server 11 contains some storing means for storing digital content and digital rights associated with the content. As previously mentioned, a large number of digital rights exists, for example “play”, “copy”, “burn to CD-R”, “transfer”, “download” etc. In this exemplifying embodiment, for the sake of simplicity, the digital rights that are used include “play unlimited” and “play #N times”. The type of access given to a proprietor of a digital right is, in this case, consequently “play”. Those skilled in the art will realize that the following reasoning could be applied to virtually any type of access.

One way of indicating whether a right is unlimited or limited is to associate an integer with the right at the server 11. A negative value on the integer indicates an unlimited right and a positive value will indicate a limited right. The positive value will indicate how many times the content can be accessed by the proprietor of the right.

DRM systems incorporate more and more different business models which requires that the DRM system is sufficiently flexible to handle many different types of rights. To facilitate the management of the digital rights for participants in DRM systems, rights are expressed using digital rights management languages. It is to be understood that such languages can be employed in the present invention to express digital rights. These languages include ODRL (Open Digital Rights Language) and XrML (Extensible Rights Markup Language). DRM languages usually conforms to a standard language notation. ODRL and XrML both allows the rights to be expressed using XML (Extensible Markup Language) notation.

The server 11 is interfaced against a network 12, such as the Internet, via which network 12 a proprietor of a digital right by means of his/her computing means, herein illustrated by computer 13, can activate a conversion mechanism at the server 11. The conversion mechanism preferably consist of a software module executed on a microprocessor implemented in the server 11. When the software module is activated by a proprietor of a number of limited rights stored at the server 11, by sending 15 a conversion instruction designating the concerned limited rights, the limited rights are converted into an unlimited right.

The instructing operation could be effected in a number of different ways, preferably the proprietor of the limited rights logs on to an account on the site of a content provider running the server 11. The proprietor transfers her limited rights, which she has procured via for example the Internet, to the account that the proprietor has at this specific content provider. The limited rights, which together must entail a sufficient number of accesses to the associated digital content for the conversion to be performed, is then marked using the mouse connected to computer 13. A message box will appear on the screen of the computer 13, which message box asks the proprietor “Convert the limited rights giving 50 accesses into an unlimited right?”. If the proprietor clicks “Yes”, the limited rights which gives a proprietor 50 accesses will be converted into an unlimited right. In this context, “the limited rights giving 50 accesses” is equivalent with 50 separate limited rights each giving a proprietor one access, in the following referred to as “50 limited rights”. It shall also be made clear that “50 limited rights” is equivalent with, for example, 25 limited rights each giving its proprietor(s) the right to access the associated content 2 times or equivalent with 10 limited rights each giving the proprietor 5 accesses. When the limited rights is converted into an unlimited right, the unlimited right is stored at the server 11.

As mentioned earlier, when converting the limited rights into an unlimited right, an agreement must be made on how many accesses that is required for the conversion of limited rights to an unlimited right to be effected. In the above example, 50 limited rights are converted into an unlimited right. This might be agreed upon at the time of conversion or alternatively, this is agreed upon in advance. This is something that the proprietor of the copyrighted content and the content provider legally have to agree upon and lies beyond the scope of the present invention. However, this agreement is not necessarily static, the conversion factor depends on the type of content and can change for any given content over time. Typically, for audio content such as a song, the newer the song, the more accesses are required when converting the limited rights to the song to an unlimited right. This can be compared to retail stores selling CDs. A new CD normally entails full price, but after some time, the CD will be less expensive to promote sales.

When the proprietor of the unlimited right wants to use her right to access the content to which the unlimited right is associated, she logs on to her account on the site of the content provider, which provider runs the server 11, by means of the computer 13 and the network 12. Under assumption that the unlimited right is a play right associated with an audio file, the proprietor can now double-click the unlimited right which has been stored at the server 11 and coupled to the account of the proprietor. This will effect 14 a playback of the audio file associated to the unlimited right. The audio filed will be streamed 15 to computer 13, and a standard playback module on the computer 13 is used to play the audio file. Since the proprietor now holds an unlimited right, the unlimited right will not be affected when the audio file is played. If, on the other hand, the proprietor would have held a number of limited rights, the number of accesses associated with the limited rights on the account of the proprietor would be decreased each time the audio file is played.

As clearly can be seen, the system described in connection to FIG. 1 is advantageous since the digital content and the associated unlimited right are stored on the server 11 of the content provider, the administration and managing of unlimited digital rights is simplified, since these are not distributed outside the server 11. This also implies that the system need not comprise any advanced security facilities for protecting unlimited rights. Since the unlimited rights are kept within the controlled framework of server 11, an unauthorized third party is prevented from eavesdropping on the network 12 and accessing/stealing the unlimited rights.

The fact that the digital content is streamed 16 from the server 11 to the computers 13 is advantageous since it obstructs a receiver of the content to store it for subsequent manipulation with the intent to access the content without possessing the proper digital rights.

In a schematic representation of a system for converting digital rights according to another embodiment of the present invention, described with reference to FIG. 2, the unlimited digital right as well as the associated content are stored on the computer 23. Assume that a user procures an audio file and an associated “play limited” right via the network 22 from an Internet server 24. The audio file and the limited right are downloaded 25 to the computer 23 from the Internet server 24. The user at the computer 23 is now a “proprietor” of a limited digital right. If the proprietor has a sufficient number of limited rights, say 50, and wants to convert the limited rights into an unlimited right, she will send 26 her 50 limited right together with a conversion instruction to the server 21 via the network 22. This is easily effected by means of a graphical user interface on the computer 23. The software module at the server 21 is activated, and the 50 limited rights are thus converted to an unlimited right. In this embodiment, when the limited rights are converted into an unlimited right at the server 21, the unlimited right is after conversion sent 27 to, and stored at, the computer 23.

The fact that the digital content and the associated unlimited right are stored at the computer 23 of a right proprietor is advantageous, since this gives the proprietor a larger degree of freedom in handling contents and rights. The proprietor need not, apart from the step of converting the limited rights into an unlimited right, operate via the server 21. Another advantage is that, when accessing the digital content, whether the access is of type play, copy, transfer etc., the proprietor need not be in contact with the server 21 of the content provider at the time of access, since the content and associated rights are stored at the computer 23 of the proprietor.

Note that it is possible that authentication may occur between any two, or more, of the devices between which communication takes place in the described embodiments. This would require the distributed information to be provided with some identifier or authenticator, for example in the form of an identification number or some type of encryption or digital signature. Authentication is typically used to improve the security in a system. Optionally, information is encrypted to prevent unauthorized third parties from eavesdropping on the network and accessing/stealing the distributed information. Exactly what security measures that must be taken by a content provider is a trade-off between the cost for implementing security facilities and the risk that the proprietor of the copyrighted content and/or the content provider will be harmed. If the digital rights are distributed from a server and stored at computers, the right itself must be copy-protected, as somebody otherwise could copy the right and produce an unlimited amount of limited digital rights.

In a schematic representation of the system for converting digital rights according to yet another embodiment the present invention, described with reference to FIG. 3, the software module for converting limited digital rights into an unlimited digital right is implemented at the computer 33 of a right proprietor. The unlimited digital right as well as the associated content are stored on the computer 33. Assume that a user procures an audio file and an associated “play limited” right via the network 32 from an Internet server 34. The audio file and the limited right are downloaded 35 to the computer 33 from the Internet server 34. The user at the computer 33 is now a “proprietor” of a limited digital right. If the proprietor has a sufficient number of limited rights, say 50, and wants to convert the limited rights into an unlimited right, she will communicate with the software module implemented in her computer 33 via a graphical user interface. The unlimited right and the audio file is stored at the computer 33. The proprietor activates the software module on the computer 33, and the 50 limited rights is thus converted into an unlimited right.

The implementation of the software module at the computer 33 of a digital right proprietor is advantageous, since it gives the proprietor freedom to perform the step of converting limited rights into an unlimited right in her computer 33, without having to send 36 a conversion instruction to the server 31. In the previously described embodiments, the server 31 performed the conversion. Consequently, the proprietor does not have to rely on a qualitative connection to the server 31, if the digital content and the associated right is downloaded 35 to the computer 33. It also has the advantage that the distributor of the software module, typically the content provider or a partner to the provider, does not have to handle the conversion for the users connected to the server 31. DRM is sometimes experienced as restrictive to the content consumers. For content consumers to accept DRM, tools such as the present invention must be as smooth as possible to use when implemented in DRM systems. Preferably, the software module must be protected when implemented at the computer 33 of a right proprietor, since the content provider no longer has the same possibility to supervise the module as in the case when the module is implemented at the server 31 of the content provider. It shall, ideally, not be possible to manipulate the software module such that to an unlimited number of limited digital rights can be produced, or in any way create a digital right which has not been issued by the content provider.

It is understood that combinations of the above described embodiments are possible. Possibly, the digital rights can be distributed to, and stored at, the computers of the users but still the content is stored at the server of the content provider for a proprietor of a digital right to stream. The term “server” can include a number of servers, either arranged as stand-alone servers or interconnected to each other in a network.

It should be noted that the above mentioned embodiments exemplify the invention, and that those skilled in the art will be able to design many alternative embodiments without departing from the scope of the appended claims. The word “comprising” does not exclude the presence of elements or steps other than those listed in a claim. The word “a” or “an” preceding an element does not exclude the presence of a plurality of such elements. In the system claims enumerating several means, several of these means can be embodied by one and the same item of hardware.

1. A method for converting digital rights, characterized in that it comprises the steps of:
storing digital content and associated limited digital rights, wherein the limited digital rights give a proprietor of the limited rights access to the content a limited number of times;
converting, when receiving an instruction in accordance therewith, the limited rights into an unlimited digital right, wherein said unlimited digital right gives a proprietor of the unlimited right access to the content an unlimited number of times.

2. The method according to claim 1, wherein digital content and associated digital rights are stored at a server of a digital content provider and the step of converting said limited rights is performed at said server, and wherein connection is established with the server, for sending the server instructions to convert said limited rights and accessing the content, from a device with computing capabilities operated by the proprietor of the digital rights.

3. The method according to claim 1, wherein digital content and associated digital rights are stored at a device with computing capabilities, which device is operated by the proprietor of the digital rights, and the step of converting said limited rights is performed at a server of a digital content provider, and wherein the content is accessed by the device and connection is established with the server for sending the server instructions to convert said limited rights.

4. The method according to claim 1, wherein digital content and associated digital rights are stored at a device with computing capabilities, which device is operated by the proprietor of the digital rights, and the step of converting said limited rights is performed at said device, and wherein the content is accessed at the device.

5. A system for converting digital rights, characterized in that it comprises:
storing means arranged to store digital content and associated limited digital rights, wherein the digital rights give a proprietor of the limited rights access to the content a limited number of times;
processing means arranged to convert, when receiving an instruction in accordance therewith, the limited digital rights into an unlimited digital right, wherein said unlimited digital right gives a proprietor of the unlimited right access to the content an unlimited number of times.

6. The system according to claim 5, further comprising a device with computing capabilities, wherein the storing means and the processing means are arranged at a server of a digital content provider, and wherein the device, operated by the proprietor of the digital rights, is arranged to establish connection with the server for sending the server instructions to convert said limited rights and for accessing the content at the server.

7. The system according to claim 5, further comprising a device with computing capabilities, wherein the storing means are arranged at the device and the processing means are arranged at a server of a digital content provider, and wherein the device, operated by the proprietor of the digital rights, is arranged to establish connection with the server for sending the server instructions to convert said limited rights and arranged to access the content in the storing means.

8. The system according to claim 6, further comprising a device with computing capabilities, wherein the storing means and the processing means are arranged at the device, and wherein the device, operated by the proprietor of the digital rights, is arranged to convert said limited rights and access the content in the storing means.
